(19) United States
(12) Patent Application Publication
(10) Pub. No.: US 2007/0039498 A1
(43) Pub. Date: Feb. 22, 2007

(54) Stamp mount assembly and related components

(76) Inventor: Mark A. Pysher, Tucson, AZ (US)

Correspondence Address: Lawrence R. Oremland, P.C., 5055 E. Broadway Boulevard Suite C-214, Tucson, AZ, 85711, US

(21) Appl. No.: 11/204,666

(22) Filed: Aug. 16, 2005

(51) Int. Cl. B41K 1/56

(52) U.S. Cl. 101/406

(57) ABSTRACT

New and useful improvements in a stamping assembly, and to components of such an assembly, are provided. Those improvements enable a single stamp mount to be conveniently coupled with or detached from a stamp structure, so that different stamp structures can be conveniently used with a single stamp mount. A stamping assembly comprises a stamp mount, a suction cup, and a stamp structure. The suction cup is designed to be mechanically coupled with the stamp mount, preferably in a manner that enables the suction cup to be conveniently coupled to and detached from the stamp mount. Moreover, the stamp mount and suction cup are configured to be pressed against a portion of the stamp structure, in a manner that can conveniently couple the stamp structure with the stamp mount, primarily by suction, and allow the stamp structure to be conveniently detached from the stamp mount. Still further, the present invention provides a new and useful stamp structure and a new and useful stamp mount structure, both of which are designed to facilitate production and use of a stamping assembly according to the principles of the present invention.

### BACKGROUND

The present invention relates to a new and useful stamp mount assembly, and to components of a stamp mount assembly. The assembly and components of the invention are particularly useful in connection with a rubber stamp for applying an image to a surface.

Stamp structures for applying an image to a surface are well known. A typical stamp structure comprises a rubber stamp supported by a stamp mount that enables the rubber stamp to be conveniently held, and maneuvered, manually, to apply an image to a surface. For example, the rubber stamp may have a visual and/or textual image that needs to be dipped into an ink pad, so that the visual and/or textual image picks up the ink that forms the image, and is then pressed against a surface (e.g. a piece of paper, a segment of fabric, etc.), to apply (transfer) the image to the surface.

It is known to provide a stamp mount and to secure the rubber stamp to the stamp mount, so that the stamp mount provides a convenient means for manipulating the rubber stamp. For example, the stamp mount may include a wooden handle, and the backside of the rubber stamp may be adhesively attached to a surface of the wooden handle, to secure the rubber stamp to the wooden handle.

It is also known to provide a stamp mount in the form of a transparent block shaped member, and to adhesively secure the backside of the rubber stamp to the transparent member. The block shaped member can then be manipulated to enable the stamp to be manipulated to apply an image to a surface. The transparent block shaped member also provides a convenient device for properly orienting the stamp relative to the surface as the image is being applied to the surface. The transparent block shaped member effectively outlines or frames the stamp, and allows the orientation of the,stamp and the surface to be conveniently viewed as the stamp is pressed against the surface to apply the image to the surface.

In the applicant's experience, when a stamp is adhesively secured to a stamp mount, that stamping assembly is relatively permanent, in the sense that the adhesively secured stamp is not intended to be detached from the stamp mount. Thus, to provide a new stamp assembly, with a different stamp, the new stamp is adhesively secured to a new stamp mount.

### SUMMARY OF THE INVENTION

The present invention provides new and useful improvements in a stamping assembly, and to components of such an assembly. Those improvements enable a single stamp mount to be conveniently coupled with or detached from a stamp structure, so that different stamp structures can be conveniently used with a single stamp mount.

A preferred version of the present invention is also designed to improve the process of stamping an image on a surface. The stamping assembly is configured to provide a compressible resilient support for the stamp, so that as the stamp is being pressed against a surface, the stamp has some ability to adjust to the contour and/or orientation of the surface.

A stamping assembly according to the present invention comprises a stamp mount, a suction cup, and a stamp structure. The suction cup is designed to be mechanically coupled with the stamp mount, preferably in a manner that enables the suction cup to be conveniently coupled to and detached from the stamp mount. Moreover, the stamp mount and suction cup are configured to be pressed against a portion of the stamp structure, in a manner that can conveniently couple the stamp structure with the stamp mount at least partially by suction, and allow the stamp structure to be conveniently detached from the stamp mount.

Thus, with the present invention, a stamp structure can be conveniently changed, by detaching the stamp structure from the stamp mount, and replacing the stamp structure with a new stamp structure that can be conveniently coupled with the stamp mount, via the suction cup.

In addition, with the preferred form of the present invention, the suction cup can also be conveniently attached and detached from the stamp mount. Thus, if a suction cup becomes less effective, e.g. due to repeated use, the suction cup can be easily and conveniently replaced.

Moreover, the preferred construction of the stamping assembly provides a resilient compressible layer between the stamp and the stamp mount. That resilient compressible layer enables the stamp some ability to adjust to the contour and/or orientation of the surface against which the stamp is being pressed, and thus improves its ability to produce a complete and relatively clean (clear) image on the surface.

Still further, the present invention provides a new and useful stamp structure and a new and useful stamp mount structure, both of which are designed to facilitate production and use of a stamping assembly according to the principles of the present invention.

Other features of the present invention will become further apparent from the following detailed description and the accompanying drawings.

### BRIEF DESCRIPTION OF THE DRAWINGS

FIG. 1 is an exploded view of components for forming a stamping assembly, according to the principles of the present invention;

FIGS. 2 and 3 are isometric top and bottom views, respectively, of a stamp mount, according to the principles of the present invention;

FIG. 4 is an end view of the stamp mount, with an attached suction cup, and showing the detail of the suction cup is coupled with the stamp mount;

FIG. 5 is a fragmentary enlarged view of and the inside wall profile in the stamp mount of the present invention; and

FIG. 6 is an end view of a stamping assembly, according to the principles of the present invention.

### DETAILED DESCRIPTION

As discussed above, the present invention provides new and useful improvements in a stamping assembly, and to components of such an assembly. The principles of the present invention are described below in connection with one example of a stamping assembly, and from that description the manner in which the principles of the present invention can be applied to various types of stamping assemblies, and to stamp mounts and stamp structures for such stamping assemblies, will be apparent to those in the art.

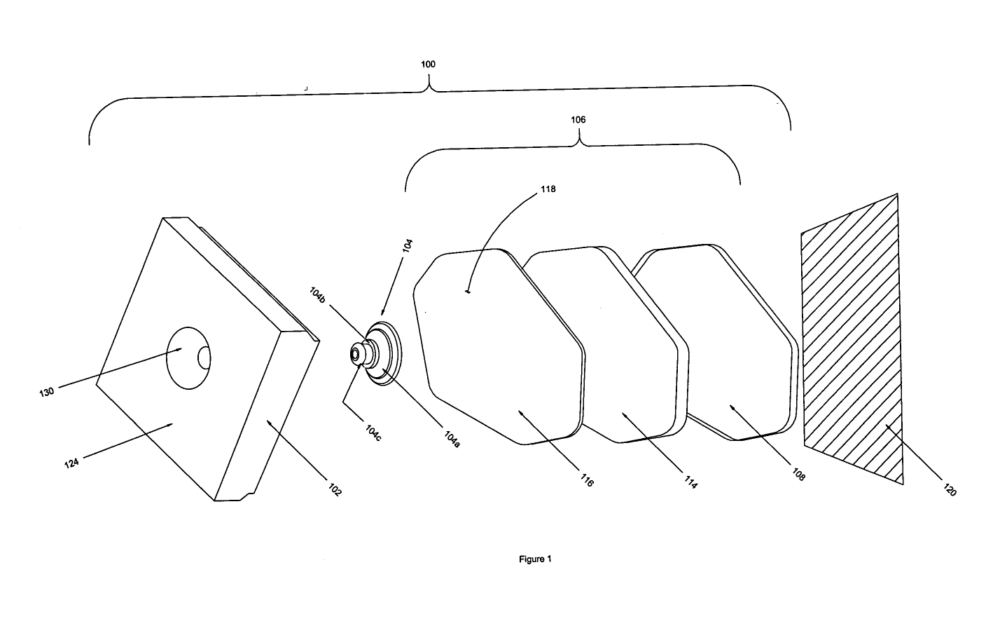

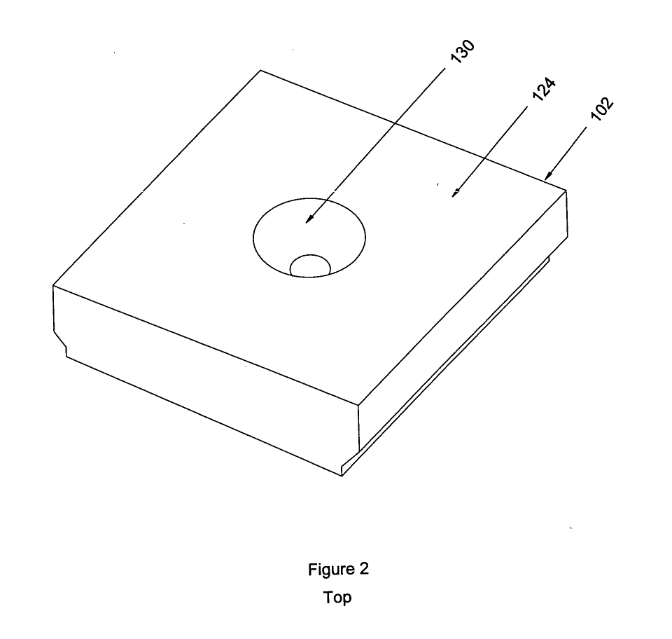

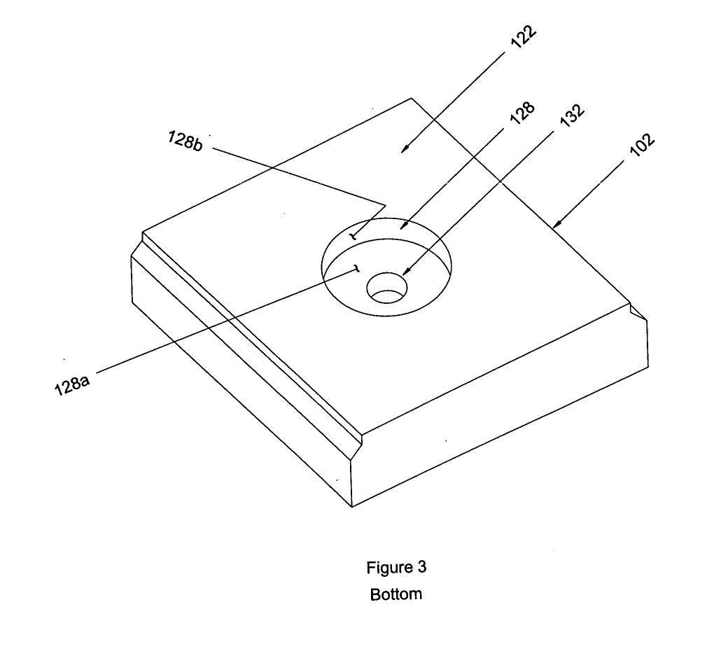

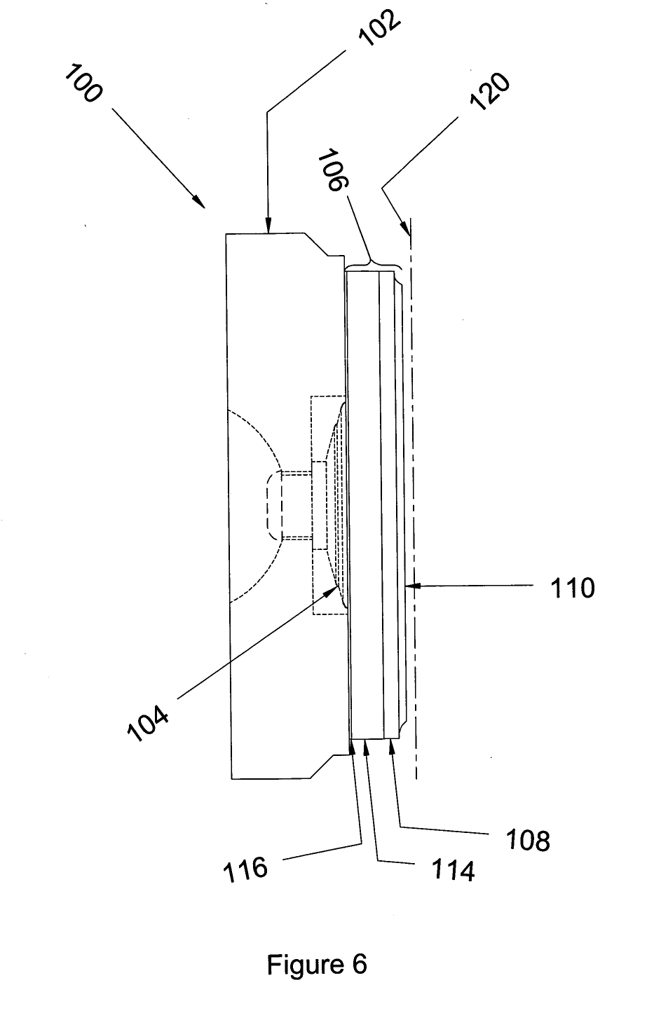

As illustrated in FIGS. 1 and 6, a stamping assembly 100 is designed to be pressed against, and transfer an image to, a surface or substrate 120 (which can be virtually any surface or substrate that can receive a transferred image). The stamping assembly 100 comprises a stamp mount 102, a suction cup 104, and a stamp structure 106. The suction cup 104 is mechanically coupled with the stamp mount 102, in a manner discussed further below. Moreover, the suction cup 104, when coupled with the stamp mount 102, is configured to be pressed against a portion of the stamp structure 106, to couple the stamp structure 106 with the stamp mount (primarily by suction). In addition, the suction cup/stamp mount can be conveniently attached with and detached from the stamp structure 106, to allow a single stamp mount/suction cup to be conveniently attached with and detached from different stamp structures. Still further, the suction cup 104 can be conveniently attached with and detached from the stamp mount 102, so that a worn suction cup 104 can be conveniently replaced, as discussed further below.

The stamp structure 106 preferably comprises a formed stamp 108 (preferably of rubber) with an image (e.g. picture and/or text) formed on a front side 110 (e.g. by embossing). A resilient compressible layer 114 (that is preferably a as a double sided adhesive foam rubber layer) is secured to the back side of the stamp 108, and a coupling layer 116 is secured to the resilient compressible layer 114. The coupling layer 116 is preferably formed of material such as rigid vinyl (e.g. 0.010″ rigid vinyl), which has a smooth, relatively rigid surface 118 that can be engaged by a suction cup 104 that is pressed against the coupling layer, to couple the stamp structure 106 with the stamp mount 102.

The stamp mount 102, which is preferably cast methyl methacrylate, has opposite front and back sides 122, 124, respectively, and an inside wall 126 that extends between the front and back sides. The inside wall 126 is formed monolithically in one piece with the stamp mount and defines a recess 128 in the front side and a recess 130 in the back side. Moreover, the inside wall 126 defines a seating/retaining ring 132, preferably located at the inner ends of the recesses 128, 130 and between the front and back sides of the stamp mount. The seating/retaining ring 132 has a central opening 132a

The suction cup 104 extends at least partially into the recess 128 in the front side of the stamp mount. The suction cup 104 has a conical portion 104a, and a ring 104b with a seating surface near the narrow end of the conical portion. In addition, the suction cup has a flexible retaining shoulder 104c at its inner end.

The recess 128 in the front side of the stamp mount 102 comprises a part of the inside wall 126, and includes a seating surface 128a that is configured to engage the seating surface on the ring 104b of the suction cup, when the suction cup 104 is coupled with the stamp mount 102. The recess 128 can be formed, e.g. by a through hole with a counter bored, flat bottom that forms the seating surface 128a, and a cylindrical side wall 128b.

The recess 130 in the backside of the stamp mount also comprises part of the inside wall 126, and is preferably a tapering, partially spherical shaped recess that extends from the back side of the stamp mount to the seating/retaining ring 132. The recess 130 can be formed, e.g. as a counter bore with a concave bottom and cylindrical wall that form the spherical shaped recess. The back side of the seating/retaining ring 132 effectively defines a retaining surface that joins with the recess 130, and mechanically retains the flexible retaining shoulder 104c of the suction cup, when the flexible retaining shoulder 104c of the suction cup has been forced through the central opening 132a in the seating/retaining ring 132.

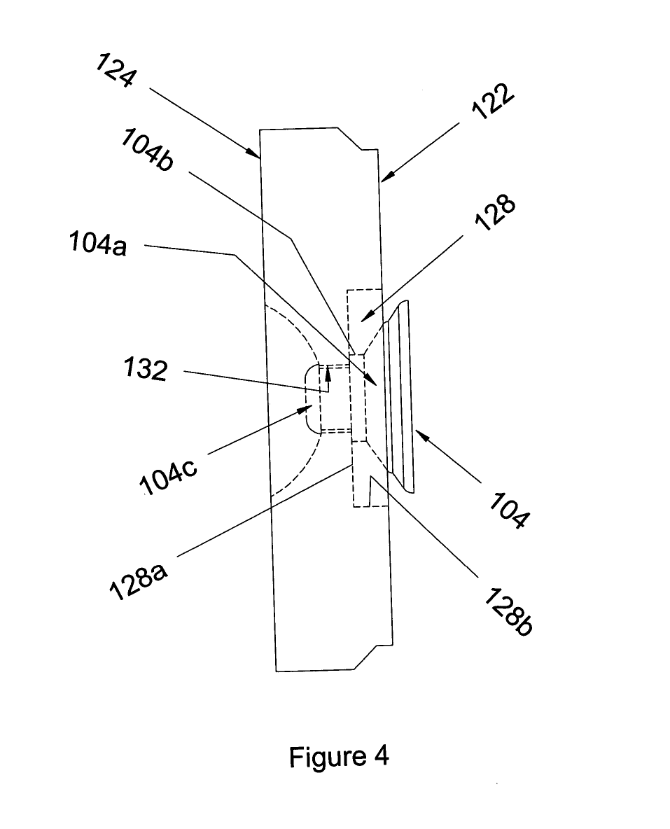

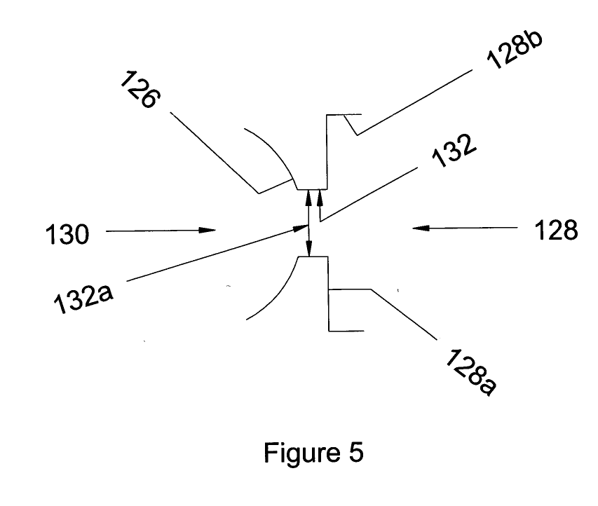

The suction cup 104 is preferably molded of a resilient resin (e.g. flexible polyvinyl chloride). The suction cup 104 is coupled with the stamp mount through the front side of the stamp mount. The narrow end of the suction cup is inserted manually into the opening 128 in the front side of the stamp mount, until the flexible retaining shoulder 104c is forced through the opening 132a in the seating/retaining ring 132. The flexibility of the resin material forming the suction cup 104 enables the flexible retaining shoulder 104c to be pressed inward as the flexible retaining shoulder engages the seating/retaining ring 132 and is inserted through the opening 132a, and then enables the flexible retaining shoulder 104c to snap outward on the backside of the seating/retaining ring 132. In that position, and as shown e.g. in FIG. 4, the seating surface of the ring 104c on the suction cup is seated on the seating surface 128a of the seating/retaining ring 132, and the flexible retaining shoulder 104c on the suction cup is behind the seating/retaining ring 132, in a manner that the suction cup should be mechanically coupled with the stamp mount (at least against accidental detachment by gravity when the stamp mount is being manipulated). The flexibility of the retaining shoulder 104d enables the suction cup 104 to be detached from the stamp mount (by relatively modest manual force) when it is desired to detach the suction cup 104 from the stamp mount 102.

In forming a stamping assembly, in which a stamp mount 102 is coupled with a stamp structure 106, the stamp structure 106 is provided as a subassembly, the suction cup 104 is mechanically coupled with the stamp mount 102 to form a subassembly, and the stamp mount/suction cup subassembly is pressed against the hard vinyl surface 118 of the stamp structure 106, so that air is forced from the conical portion of the suction cup, and the stamp mount/suction cup subassembly is coupled with the stamp structure 106, primarily by suction between the suction cup and the surface 118. The stamp mount/suction cup subassembly should remain coupled with the stamp structure 106, until sufficient force is applied (manually) to the stamp mount/suction cup subassembly and/or stamp structure to pull those components apart. A different stamp structure 106 can then be coupled with the same stamp mount/suction cup subassembly, in the manner described above.

The resilient compressible layer 114 that forms part of the stamp structure 106 provides the additional useful feature of enabling some degree of resilient compression of portions of the stamp 108 as the stamp structure is being pressed against a surface 120. The resilient compressible layer 114 enables the stamp 108 (and/or portions of the stamp) some ability to adjust (resiliently) to the contour and/or orientation of the surface 120 against which the stamp is being pressed, and thus improves the ability of the stamping assembly to produce a complete and relatively clean (clear) stamped image on the surface. The resilient layer 114 is preferably a layer of foam rubber with adhesive on its opposite sides, and peel off strips covering the adhesive, so that the stamp assembly can be conveniently formed by peeling the strips off the adhesive, adhesively securing one side of the foam rubber layer to the back side of the stamp 108, and adhesively securing the rigid vinyl material 116 to the other side of the foam rubber, so that the surface 118 of the rigid vinyl material 116 forms the back surface of the stamp structure.

Thus, from the foregoing description, it should be clear to those in the art that the suction cup can be conveniently coupled with and detached from the stamp mount, and that the stamp structure can be conveniently coupled with and detached from the stamp mount, via the suction cup.

In addition, it is preferred that the stamp mount is formed of transparent material, so that the stamp mount effectively outlines or frames the stamp, and allows the orientation of the stamp and the surface to be conveniently viewed as the stamp is pressed against the surface to apply the image to the surface.

It is also worth noting that while the foregoing description relates to a stamp mount with a single suction cup, it is contemplated that a stamp mount could be formed with a plurality of openings, each of which is configured to be mechanically coupled with a respective suction cup, so that a single stamp mount could be coupled to a plurality of stamp structures, and can be used to press the plurality of stamp structures against a surface.

Accordingly, the foregoing description provides new and useful principles of forming a stamping assembly, and components of such an assembly. From that description the manner in which the principles of the present invention can be applied to various types of stamping assemblies, and to stamp mounts and stamp structures for such stamping assemblies, will be apparent to those in the art.

1. Stamp support structure that can be used to apply a stamped image to a surface, comprising a stamp mount configured to be mechanically coupled with and detached from a suction cup, and the stamp mount being formed of transparent material, so that at least a portion of a surface can be viewed through the stamp mount.

2. Stamp support structure as defined in claim 1, wherein the stamp mount has opposite first and second sides and an inside wall extending between the first and second sides; the inside wall configured to define (i) a recess in the first side and (ii) a retaining ring spaced from the first side; the retaining ring defining (i) on one side a seat for a portion of a suction cup located in the recess, and (ii) on the other side a retaining surface that is configured to retain a flexible retaining shoulder on a suction cup that is disposed in the recess and coupled with the stamp mount.

3. Stamp structure as defined in claim 2, wherein the retaining ring is located between the first and second sides of the recess in the stamp mount.

4. Stamp structure as defined in claim 3, wherein the inside wall is monolithically formed in one piece with the stamp mount.

5. Stamp structure that is configured to be selectively coupled with and detached from a stamp mount, comprising a stamp component that has an image on one side, and an opposite side that is configured to be selectively engaged by a suction cup, to selectively couple the stamp structure with a stamp mount.

6. Stamp structure as defined in claim 5, wherein the stamp structure comprises a rubber stamp with the image on one side, a resilient compressible layer on the other side and a material secured to the resilient compressible layer on the other side, the material having a surface that can be selectively engaged by a suction cup to couple the stamp structure with a stamp mount.

7. Stamp structure as defined in claim 6, wherein the material comprises a rigid vinyl material.

8. Stamp structure as defined in claim 7, wherein the resilient compressible layer comprises a layer of foam rubber with adhesive on its opposite sides.

9. A stamping assembly comprising a stamp mount, a suction cup, and a stamp structure, the suction cup mechanically coupled with the stamp mount, and configured to be pressed against a portion of the stamp structure to couple the stamp structure with the stamp mount at least partially by suction.

10. A stamping assembly as defined in claim 9, wherein the stamp structure comprises a formed stamp with an image on one side a resilient compressible layer secured to the other side of the formed stamp, and a coupling layer secured to the resilient compressible layer, the coupling layer formed of material that can be selectively engaged by a suction cup that is pressed against the coupling layer, to selectively couple the formed stamp with the stamp mount.

11. A stamping assembly as defined in claim 10, wherein the material comprises a rigid vinyl material.

12. A stamping assembly as defined in claim 11, wherein the stamp mount has opposite first and second sides and an inside wall extending between the first and second sides, the inside wall configured to define a recess in the first side and a seating/retaining ring spaced from the first side; the suction cup extending at least partially into the recess in the first side and the seating/retaining ring defining on one side a seat for a portion of the suction cup located in the recess; the portion of the suction cup extending into the recess further including a flexible retaining shoulder and the seating/retaining ring defining on its other side a retaining surface that is configured to retain the flexible retaining shoulder of a suction cup that is disposed in the recess, to couple the suction cup with the stamp mount.

13. A stamping assembly as defined in claim 12, wherein the inside wall is monolithically formed in one piece with the stamp mount.

14. A stamping assembly as defined in claim 13, wherein the retaining ring is located between the first and second sides of the recess in the stamp mount.

15. A stamping assembly as defined in claim 14, wherein the suction cup has a conical portion with the seating surface and the flexible retaining shoulder near the narrow end of the conical portion, and wherein the opening in the stamp mount includes a tapering recess extending from the second side of the stamp mount to the seating/retaining ring.

16. A stamping assembly as defined in claim 15, wherein the stamp mount is formed of transparent material, so that the position of the stamp relative to the stamp mount can be viewed through the stamp mount.

17. A stamping assembly as defined in claim 9, wherein the stamp mount has opposite first and second sides and an inside wall extending between the first and second sides, the inside wall configured to define a recess in the first side and a seating/retaining ring spaced from the first side; the suction cup extending at least partially into the recess in the first side and the seating/retaining ring defining on one side a seat for a portion of the suction cup located in the recess; the portion of the suction cup extending into the recess further including a flexible retaining shoulder and the seating/retaining ring defining on its other side a retaining surface that is configured to retain the flexible retaining shoulder of a suction cup that is disposed in the recess, to couple the suction cup with the stamp mount.

16. A stamping assembly as defined in claim 15, wherein the retaining ring is located between the first and second sides of the recess in the stamp mount

17. A stamping assembly as defined in claim 16, wherein the inside wall is monolithically formed in one piece with the stamp mount.

18. A stamping assembly as defined in claim 17, wherein the suction cup has a conical portion with the seating surface and the flexible retaining shoulder near the narrow end of the conical portion, and wherein the opening in the stamp mount includes a tapering recess extending from the second side of the stamp mount to the seating/retaining ring.

19. A stamping assembly as defined in claim 18, wherein the stamp mount is formed of transparent material, so that the position of the stamp relative to the stamp mount can be viewed through the stamp mount.
